(19) United States
(12) Patent Application Publication
(10) Pub. No.: US 2013/0300760 A1
(43) Pub. Date: Nov. 14, 2013

(54) IMAGE DISPLAY APPARATUS, IMAGE DISPLAY PROGRAM, AND IMAGE DISPLAY METHOD

(71) Applicant: SONY CORPORATION, Tokyo (JP)

(72) Inventors: Hisako Sugano, Kanagawa (JP); Masatoshi Ueno, Kanagawa (JP); Kenichi Kabasawa, Saitama (JP); Daisuke Kawakami, Kanagawa (JP); Shinobu Kuriya, Kanagawa (JP); Tetsuro Goto, Tokyo (JP); Tsubasa Tsukahara, Tokyo (JP); Toshiyuki Nakagawa, Kanagawa (JP)

(73) Assignee: Sony Corporation, Tokyo (JP)

(21) Appl. No.: 13/871,705

(22) Filed: Apr. 26, 2013

(30) Foreign Application Priority Data
May 8, 2012 (JP) 2012-106479

(51) Int. Cl. G06T 11/60

(52) U.S. Cl. CPC G06T 11/60
USPC 345/592; 345/634

(57) ABSTRACT

An image display apparatus includes a see-through display, an image mask generator, an image generator, and an image display unit. The see-through display is located before an eye of a user. The image mask generator is configured to generate an image mask. The image generator is configured to generate a display image with the image mask being overlapped with an original image. The image display unit is configured to display the display image on the see-through display.

### CROSS REFERENCES TO RELATED APPLICATIONS

The present application claims priority to Japanese Priority Patent Application JP 2012-106479 filed in the Japan Patent Office on May 8, 2012, the entire content of which is hereby incorporated by reference.

### BACKGROUND

The present disclosure relates to an image display apparatus, an image display program, and an image display method pertaining to generation of an image to be displayed on a see-through display.

There is a head-mounted display that is mounted on the head of a user and displays an image on a display provided before an eye of the user. In such a head-mounted display, the user views an image displayed on the display.

In audio reproduction apparatuses including headphones or earphones, there is one having a noise canceling function that cuts off noise other than reproduced audio. For example, Japanese Patent Application Laid-open No. 2000-242277 and Japanese Patent Application Laid-open No. 2010-243844 disclose audio reproduction apparatuses having such a noise canceling function.

### SUMMARY

The technique of reducing audio noise as in the apparatuses described in Patent Documents above is known but a technique of reducing visual noise is not known. For example, when the user views an object (e.g., book) that he or she wishes to attentively view, if visibility of objects (noise) surrounding that object can be limited, the user can concentrate on viewing the object that he or she wishes to attentively view.

In view of the above-mentioned circumstances, it is desirable to provide an image display apparatus, an image display program, and an image display method, that enable a user to concentrate on viewing an object that he or she wishes to attentively view.

According to an embodiment of the present disclosure, there is an image display apparatus including a see-through display, an image mask generator, an image generator, and an image display unit.

The see-through display is located before an eye of a user.

The image mask generator is configured to generate an image mask.

The image generator is configured to generate a display image with the image mask being overlapped with an original image.

The image display unit is configured to display the display image on the see-through display.

With this configuration, an area of the display image that corresponds to the image mask, the original image is not displayed. Here, in the area in which the image is not displayed (non-display area) in the see-through display, the user can view an outside through the see-through display. Therefore, the user can view an object that he or she wishes to attentively view through the non-display area. Meanwhile, the original image is displayed in an area (display area) other than the non-display area, and hence the view to the outside is blocked in the display area. As a result, the user can concentrate on viewing that object.

The image display apparatus further may include an imaging unit configured to capture a capture image, and an object image extraction unit configured to extract, from the capture image, an object image being an image of an object included in a field of view of the imaging unit, in which the image mask generator may be configured to generate an image mask by utilizing a range of the object image in the capture image.

With this configuration, the image display apparatus can generate the image mask by utilizing a range of the object image extracted from the capture image. That is, the image mask corresponding to the object is automatically generated and the user can view the object.

With this configuration, the object image extraction unit may be configured to execute edge detection with respect to the capture image and extract the object image.

With this configuration, the object image extraction unit can extract the object image in the capture image by the edge detection.

The image mask generator may be configured to set the range of the object image as the image mask.

With this configuration, the image mask generator can generate the image mask corresponding to the range of the object image.

The image mask generator may be configured to set a range specified by the user as the image mask.

With this configuration, the user can arbitrarily set a range to become the image mask. The user can select an arbitrary one from candidates of the image mask prepared in advance or draw the range to become the image mask himself or herself.

The image generator may be configured to make a periphery of the image mask blurred and overlap the image mask with the original image.

With this configuration, the user can view the display image in which a boundary between the display area in which the original image is displayed and the non-display area for viewing the object is made blurred.

The image generator may be configured to make the original image a semi-transparent image.

With this configuration, the user can also view the surroundings of the object that he or she wishes to attentively view via the original image made the semi-transparent image. Meanwhile, the visibility of the surroundings of the object is lowered due to the original image made the semi-transparent image, and hence the user can concentrate on viewing that object without obstruction.

According to another embodiment of the present disclosure, there is provided an image display program including an image mask generator, an image generator, and an image display unit.

The image mask generator is configured to generate an image mask.

The image generator is configured to generate a display image with the image mask being overlapped with an original image.

The image display unit is configured to display the display image on a see-through display located before an eye of a user.

According to an embodiment of the present disclosure, there is provided an image display method, in which an image mask generator generates an image mask.

An image generator generates a display image with the image mask being overlapped with an original image.

An image display unit displays the display image on a see-through display located before an eye of a user.

As mentioned above, according to the embodiments of the present disclosure, it is possible to provide an image display apparatus, an image display program, and an image display method, that enable a user to concentrate on viewing an object that he or she wishes to attentively view.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic view showing an outer appearance of an image display apparatus according to a first embodiment of the present disclosure;

FIG. 2 is a schematic view showing functional configurations of the image display apparatus according to the first embodiment of the present disclosure;

FIG. 3 is a flowchart showing operations of the image display apparatus;

FIG. 4 is a schematic view showing an original image set in the image display apparatus;

FIG. 5 is a schematic view showing a capture image captured by a camera of the image display apparatus;

FIG. 6 is a schematic view showing an object image extracted by an object image extraction unit of the image display apparatus;

FIG. 7 is a schematic view showing a range of the object image extracted by the object image extraction unit of the image display apparatus;

FIG. 8 is a schematic view showing an image mask generated by an image mask generator of the image display apparatus;

FIG. 9 is a schematic view showing a display image generated by an image generator of the image display apparatus;

FIG. 10 is a schematic view showing the display image displayed on a display by an image display unit of the image display apparatus;

FIG. 11 is a schematic view showing vision viewed by a user through the display of the image display apparatus;

FIG. 12 is a schematic view showing vision viewed by the user through the display of the image display apparatus;

FIG. 13 is a schematic view showing vision viewed by the user through the display of the image display apparatus;

FIGS. 14A to 14B are schematic views each showing another example of an image mask generated by the image mask generator of the image display apparatus;

FIGS. 15A and 15B are schematic view each showing another example of an image mask generated by the image mask generator of the image display apparatus;

FIG. 16 is a schematic view showing functional configurations of an image display apparatus according to a second embodiment of the present disclosure;

FIG. 17 is a flowchart showing operations of the image display apparatus;

FIGS. 18A to 18C are schematic views each showing an image mask specified by the user with respect to the image display apparatus;

FIGS. 19A to 19C are schematic views each showing the image mask specified by the user with respect to the image display apparatus;

FIG. 20 is a schematic view showing the display image generated by an image generator of the image display apparatus;

FIG. 21 is a schematic view showing a display image to be displayed on a display by an image display unit of the image display apparatus; and

FIG. 22 is a schematic view showing vision viewed by the user through the display of the image display apparatus.

### DETAILED DESCRIPTION

### First Embodiment

[Configuration of Image Display Apparatus]

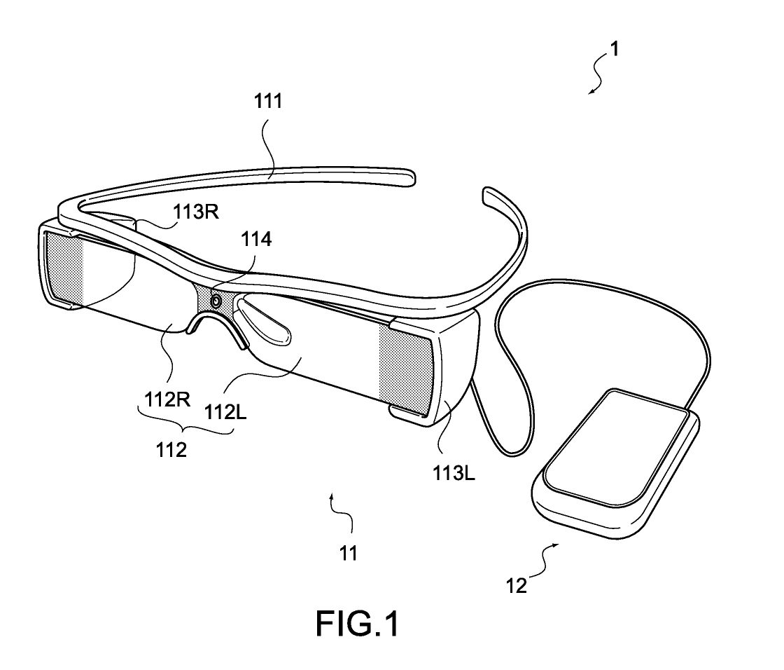

An image display apparatus according to a first embodiment of the present disclosure will be described. FIG. 1 is a schematic view showing an outer appearance of an image display apparatus 1. As shown in the figure, the image display apparatus 1 includes head portion equipment 11 and an operation device 12. The head equipment 11 and the operation device 12 are connected to each other in a wired or wireless manner.

The head equipment 11 is configured to be mountable on the head of a user. The head equipment 11 includes a display located before an eye of the user when the head equipment 11 is mounted on the head of the user. The head equipment 11 displays an image on the display. Specifically, the head equipment 11 includes a supporter 111, displays 112 (112R and 112L), image generation units 113 (113R and 113L), and a camera 114.

The supporter 111 supports the head equipment 11 on the head of the user. The supporter 111 may abut against the ears and nose of the user. The shape, material, and the like of the supporter 111 may be arbitrary.

The displays 112 are supported by the supporter 111 and located before the eyes of the user. In this state, the displays 112 display images generated by the image generation units 113. The displays 112 are see-through displays that are transparent and do not block a field of view of the user in a state in which the displays 112 do not display images. Note that the displays 112 do not need to be completely transparent. As shown in FIG. 1, the displays 112 may include a right display 112R located before the right eye of the user and a left display 112L located before the left eye of the user. Alternatively, an integrated display to be located before the both eyes of the user may be adopted.

The image generation units 113 are supported by the supporter 111. The image generation units 113 generate images to be displayed on the displays 112 (hereinafter, referred to as display images), and provide the images and display the images on the displays 112. Further, the image generation units 113 are connected to the camera 114. The image generation units 113 may acquire images captured by the camera 114. As shown in FIG. 1, the image generation units 113 may include a right image generation unit 113R that provides the display image to the right display 112R and a left image generation unit 113L that provides the display image to the left display 112L. Further, the image generation units 113 may be integrally configured.

The camera 114 is supported on the supporter 111 and captures an image. The camera 114 may be located such that a field of view of the camera 114 almost corresponds to the field of view of the user when the head equipment 11 is mounted on the head of the user. For example, the camera 114 is favorably located at a middle position between the right display 112R and the left display 112L.

The operation device 12 receives an operation input of the user with respect to the head equipment 11. The operation device 12 is not particularly limited, and may be an information processing apparatus such as a smart phone or a remote controller. Further, the operation device 12 may function as a device that provides the head equipment 11 with images being originals of the display images to be displayed on the displays 112 (hereinafter, referred to as original images). The operation device 12 provides operation inputs by the user and the original images to the image generation units 113.

The image display apparatus 1 may have the above-mentioned configuration. Note that the configuration of the image display apparatus 1 is not limited to the above-mentioned configuration. For example, the function corresponding to the operation device 12 may be installed into the head equipment 11.

[Functional Configurations of Image Display Apparatus]

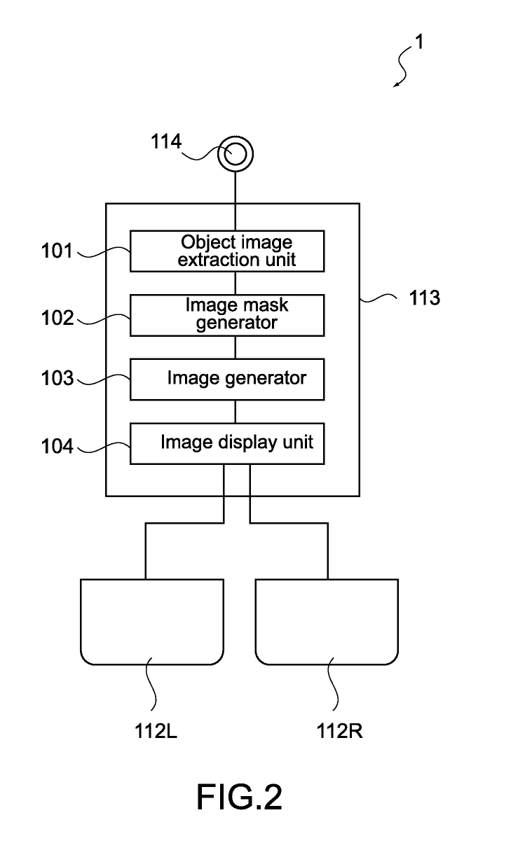

In the image display apparatus 1, the above-mentioned configuration and the following functional configurations are realized by cooperation of software. FIG. 2 is a schematic view showing the functional configurations of the image display apparatus 1. As shown in the figure, the image display apparatus 1 includes an object image extraction unit 101, an image mask generator 102, an image generator 103, and an image display unit 104. Each of the configurations may be incorporated in the image generation units 113. The object image extraction unit 101 is connected to the camera 114. The image display unit 104 is connected to the displays 112 (right display 112R and left display 112L). The object image extraction unit 101, the image mask generator 102, the image generator 103, and the image display unit 104 are connected to one another.

The object image extraction unit 101 executes object image extraction processing with respect to the capture image captured by the camera 114, and extracts the object image. The object image is an image of an object included in the field of view of the camera 114. The object image extraction unit 101 may execute edge detection processing or the like to be described later with respect to the capture image and extract the object image. The object image extraction unit 101 provides a range in the capture image of the extracted object image (hereinafter, referred to as object image range) to the image mask generator 102.

The image mask generator 102 generates an “image mask.” The image mask is a range within which an overlapping image (original image to be described later) is not displayed. The image mask generator 102 may generate the image mask by utilizing an object image range provided from the object image extraction unit 101. Specifically, the image mask generator 102 may set the image mask as it is by utilizing the object image range. Alternatively, the image mask generator 102 may generate the image mask by changing the size of the object image range. The image mask generator 102 provides the generated image mask to the image generator 103.

The image generator 103 generates the display image with the image mask being overlapped with the “original image.” The “original image” is not particularly limited, and may be a monochromatic image, an image specified by the user (including one frame of moving image), or the like. The image generator 103 may generate the original image by itself. Alternatively, the image generator 103 may use an image provided from the operation device 12 or the like in response to specification from the user, as the original image. The image generator 103 provides the generated display image to the image display unit 104.

The image display unit 104 provides the display image to the display 112 and displays the display image on the display 112. As described above, the image mask is overlapped on the display image, and hence the original image is not displayed in an area of the display image that corresponds to the image mask (hereinafter, referred to as non-display area). The display 112 is the see-through display, and hence the user can view an external world through the non-display area. That is, the user can view the above-mentioned “object.” On the other hand, the original image is displayed in an area other than the non-display area (hereinafter, referred to as display area). Therefore, the field of view of the user is limited to the above-mentioned object (and the surroundings thereof).

The image display apparatus 1 has the above-mentioned functional configurations.

[Operations of Image Display Apparatus]

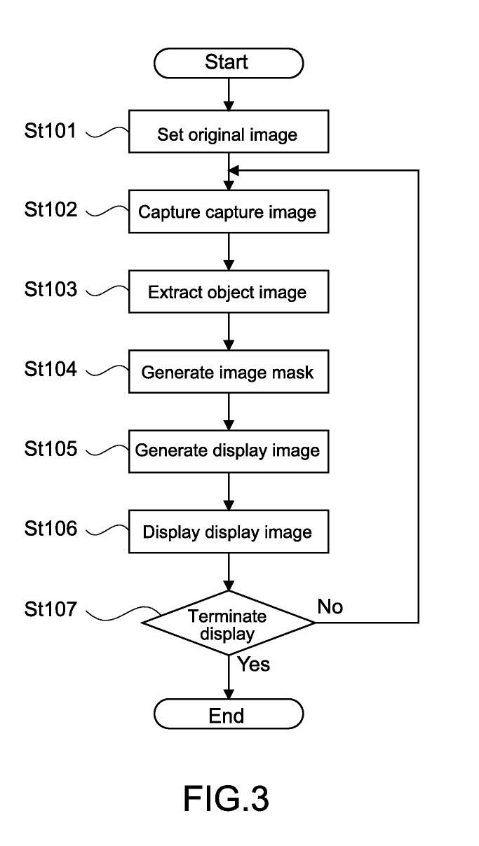

Operations of the image display apparatus 1 will be described. FIG. 3 is a flowchart showing the operations of the image display apparatus 1.

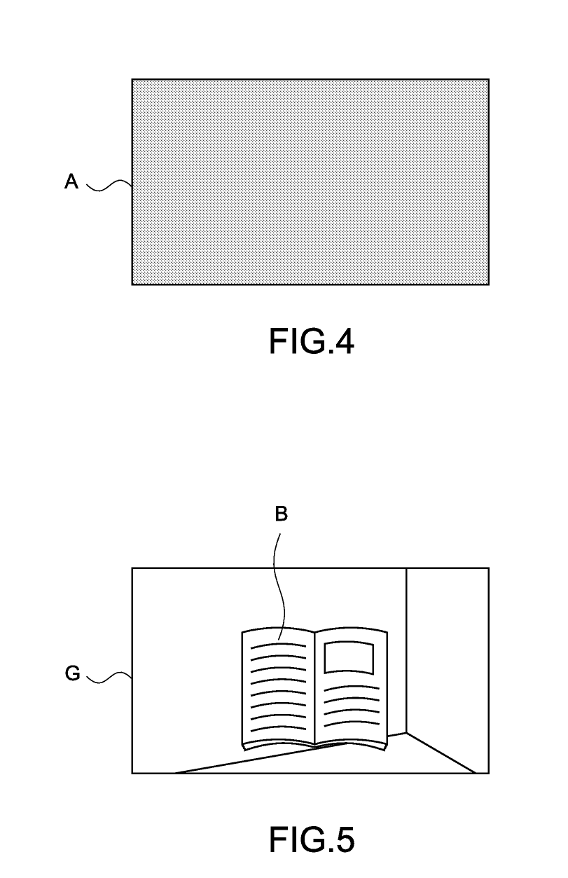

First, the original image is set by the user or the image generator 103 (St101). By operating the operation device 12, the user can select an arbitrary still image or an arbitrary moving image. The selected still image or (each frame of) the selected moving image is set as the original image. Otherwise, if the user does not select the original image, an image set by the image generator 103 in advance is set as the original image. An example of the original image set in FIG. 4 is shown as an original image A.

Subsequently, the camera 114 captures a capture image (St102). FIG. 5 shows an example of the capture image (hereinafter, referred to as capture image G). As shown in the figure, the capture image G includes an object B (here, book) present within the range of the field of view of the camera 114. The object B is not limited to one object B and a plurality of objects B may be adopted. Note that, although the range of the field of view of the camera 114 may include objects on a rear side of the object B, those objects can be separated from the object B utilizing a difference in distance between those objects and the object B. In the following description, the objects on the rear side are referred to as a “background.”

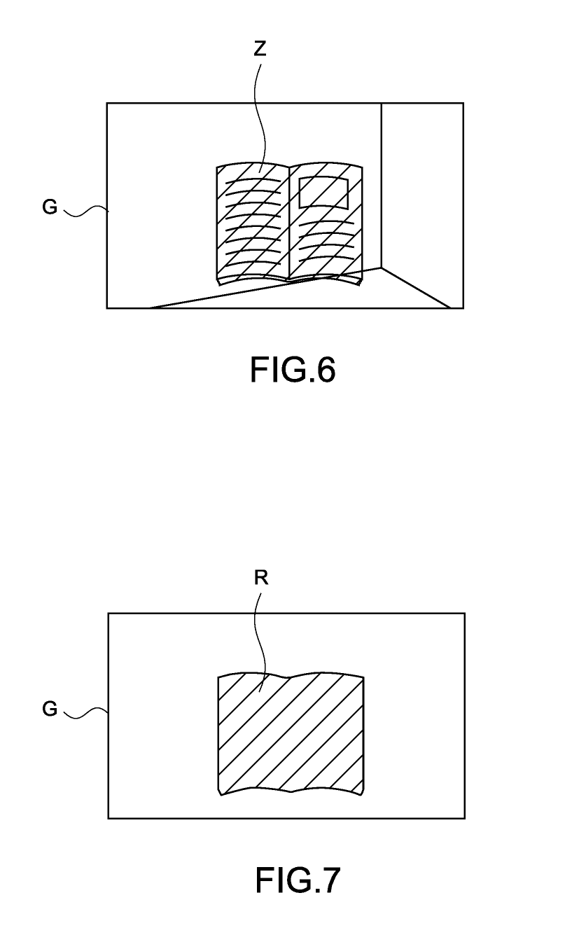

Subsequently, the object image extraction unit 101 extracts an image of the object B (hereinafter, referred to as object image) in the capture image G (St103). FIG. 6 shows the object image (hereinafter, referred to as object image Z) extracted by the object image extraction unit 101, as a shaded area. The object image extraction unit 101 may extract the object image Z by various methods. The object image extraction unit 101 may extract the object image Z by edge detection processing with respect to the capture image G, for example. Note that, in the case where a plurality of objects B are present, the object image extraction unit 101 may extract each object image.

Although the edge detection processing includes a differential method, the Roberts, the Prewitt, the Sobel, and the like, any of them may be employed. Further, other than the method utilizing the edge detection processing, the object image extraction unit 101 may use various methods such as a luminance detection method, an area dividing method, a split-and-merge method, and a color difference detection method to extract the object image Z. Alternatively, the object image extraction unit 101 may utilize a plurality of capture images continuously captured to extract the object image Z by a dynamic contour method, for example. The object image extraction unit 101 provides the image mask generator 102 with a range R of the object image B that occupies the capture image G (hereinafter, referred to as object image range). FIG. 7 is a schematic view showing the object image range R.

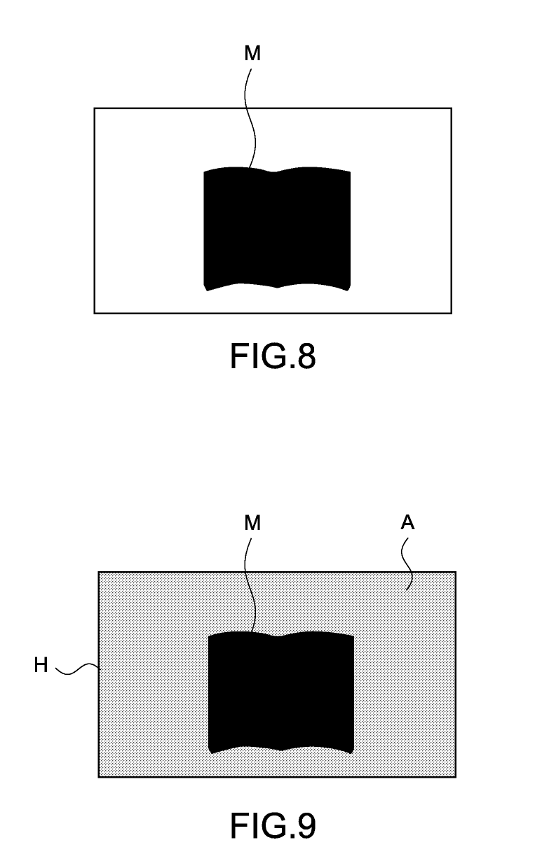

Subsequently, the image mask generator 102 generates the image mask by utilizing the object image range (St104). FIG. 8 is a schematic view showing generation of the image mask. As shown in FIG. 8, the image mask generator 102 may set an object image range R as an image mask (hereinafter, referred to as image mask M) as it is. In the case where a plurality of object image ranges are present, the image mask generator 102 may set a range obtained by combining the plurality of object image ranges, as the image mask M. Although the image mask generator 102 may generate the image mask M by utilizing the object image range R other than setting the object image range R as the image mask M as it is, this will be described later.

Subsequently, the image generator 103 generates the display image (St105). FIG. 9 is a schematic view showing an example of the display image (hereinafter, referred to as display image H). As shown in the figure, the image generator 103 may generate the display image H with the image mask M being overlapped with the original image A (see FIG. 4). In this case, the image generator 103 generates the display image H with the luminance of the image mask M being set to zero (black as color). The image generator 103 positions the original image A with respect to the capture image G from which the image mask M is generated, and overlaps the image mask M on the original image A. If the original image A and the capture image G are different in size and shape, the image generator 103 may perform positioning such that centers of the both correspond to each other, for example.

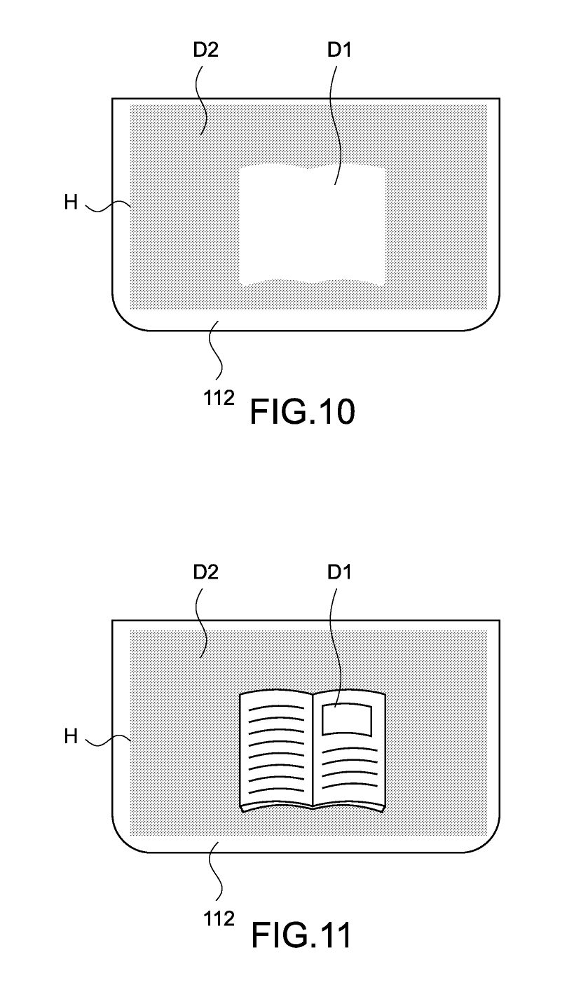

Subsequently, the image display unit 104 provides the display images H to the displays 112 and causes the displays 112 to display the display images H (St106). FIG. 10 is a schematic view showing one of the display images H to be displayed on the displays 112 (right display 112R and left display 112L). As shown in the figure, the luminance of an area (non-display area) D1 corresponding to the image mask M of the display image H is set to zero, and hence nothing is displayed in that area. On the other hand, the original image A is displayed in an area (display area) D2 other than the area corresponding to the image mask M.

Here, the display 112 is the see-through display, and hence the user can view the object B through the non-display area D1. FIG. 11 is a schematic view showing vision viewed by the user through the displays 112. As shown in the figure, the user can view the object B through the non-display area D1. On the other hand, the original image A is displayed in the display area D2. With this, the user can view the object B without viewing the surroundings (background) of the object B.

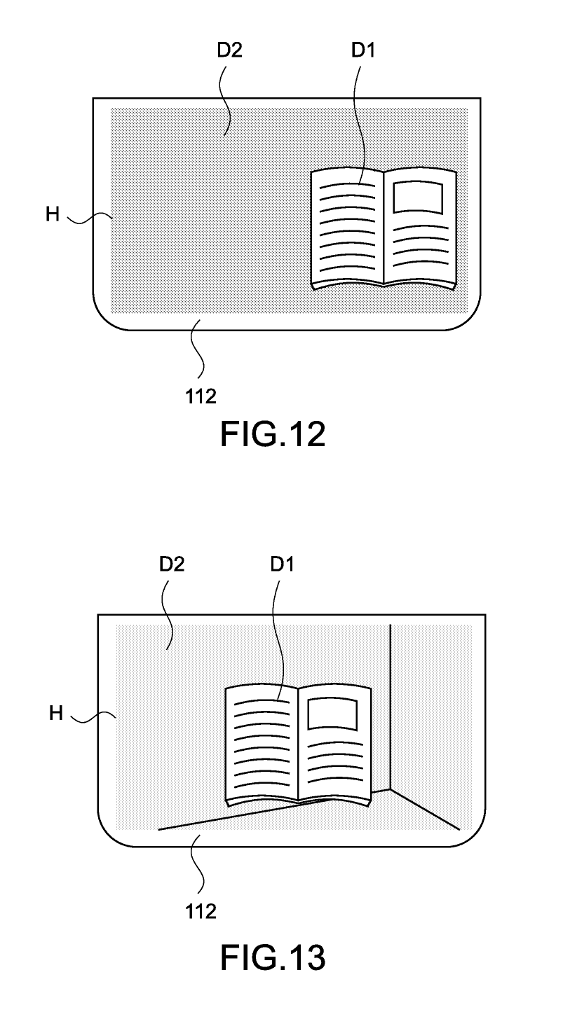

Unless displaying of the display image is stopped by the user (St107: No), steps from capturing of the capture image (St102) to displaying of the display image (St106) may be repeatedly performed. With this, when the object B moves or the user changes the orientation of the head equipment 11, the non-display area Dl moves following the object B and the user keeps viewing the object B as shown in FIG. 12. When displaying of the display image is stopped by the user (St107: Yes), displaying of the display image H is terminated.

The image display apparatus 1 performs the operations in the above-mentioned manner. Here, the operations of the image display apparatus 1 are not limited to those set forth herein. For example, when the image display unit 104 displays the original image A in the display area D2 (St106), semi-transparent processing may be performed on the original image A. FIG. 13 is a schematic view showing vision viewed by the user through the display 112 when the semi-transparent processing is performed on the original image A. As shown in the figure, the user can view the background of the object B through the original image A in a semi-transparent state.

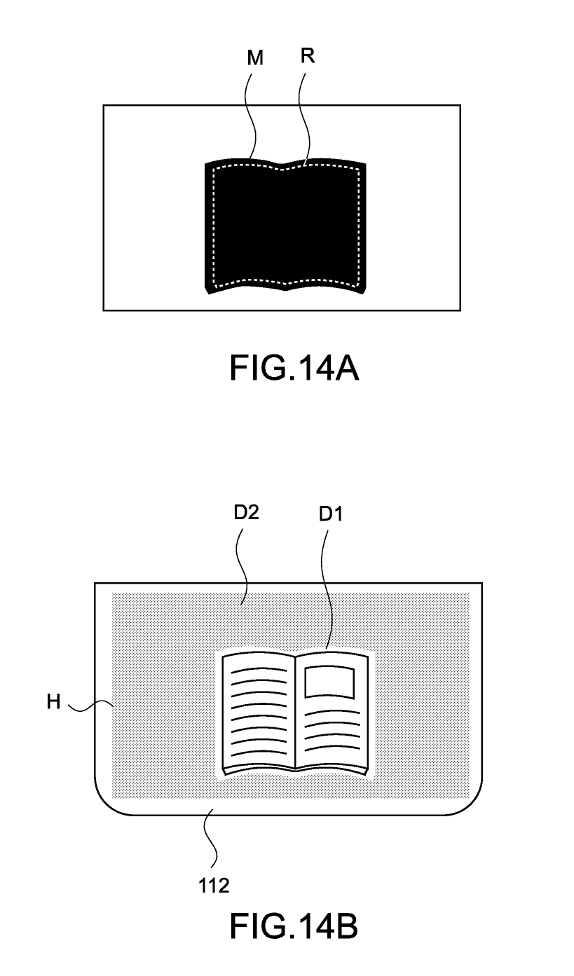

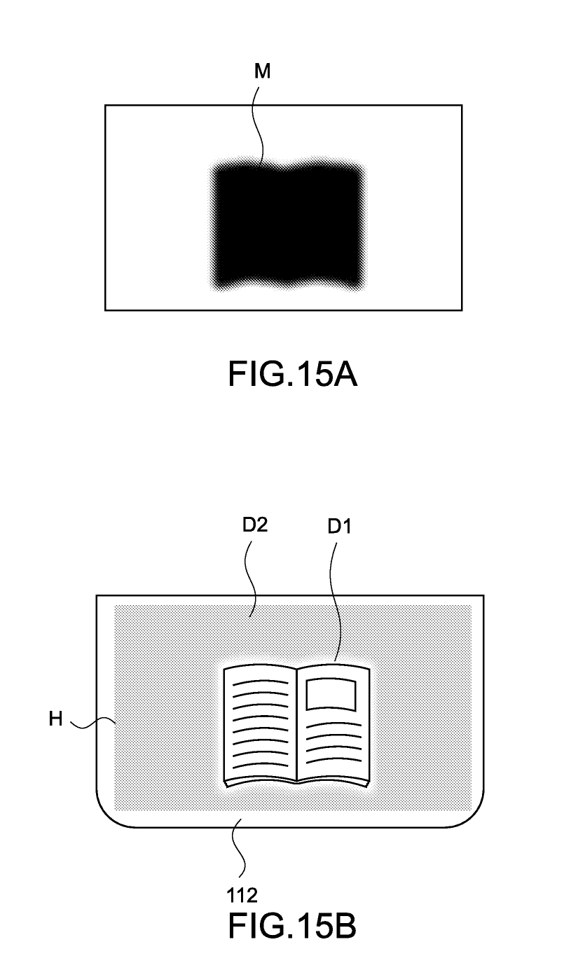

Further, in the above description, the image mask generator 102 sets the object image range R as the image mask M as it is (St102). Other than this, the image mask generator 102 may generate the image mask M by utilizing the object image range R. FIGS. 14 and 15 are schematic views showing other examples of the image mask M to be generated by the image mask generator 102.

As shown in FIG. 14A, the image mask generator 102 may set a range obtained by enlarging the object image range R (see FIG. 7) at a predetermined ratio, as the image mask M. The magnification ratio may be set in advance or may be specified by the user. With this, as shown in FIG. 14B, the user can view the object B and the surroundings of the object B.

Further, as shown in FIG. 15A, the image mask generator 102 may generate the image mask M with the periphery of the object image range R being made blurred (blur processing). Whether or not making the periphery blurred or a degree by which the periphery is made blurred may be set in advance or may be specified by the user. With this, as shown in FIG. 15B, the user can view the original image A in which a boundary with respect to the object B is made blurred.

### Second Embodiment

An image display apparatus according to a second embodiment of the present disclosure will be described. Note that, in this embodiment, descriptions of configurations common to the first embodiment will be omitted. The image display apparatus according to the second embodiment has the same outer appearance and hardware configuration as those of the first embodiment. However, the image display apparatus according to the second embodiment does not necessarily need the camera.

[Functional Configurations of Image Display Apparatus]

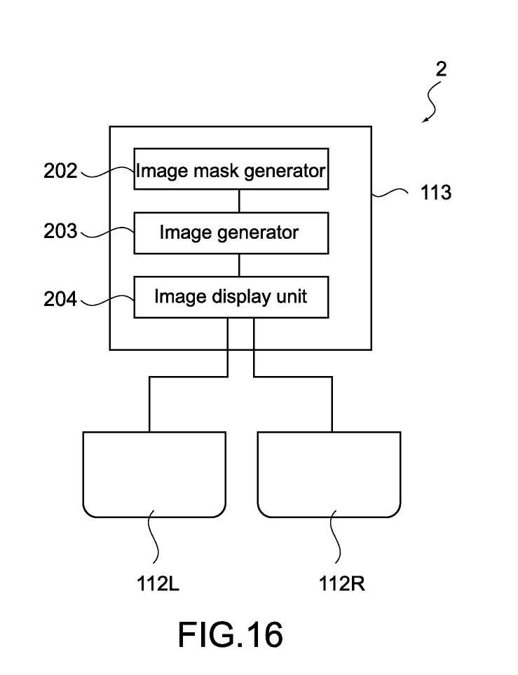

FIG. 16 is a schematic view showing functional configurations of an image display apparatus 2 according to the second embodiment of the present disclosure. As shown in the figure, the image display apparatus 2 includes an image mask generator 202, an image generator 203, and an image display unit 204. Each of the configurations may be incorporated in the image generation units 113 (see FIG. 1). The image display unit 204 is connected to displays 112 (right display 112R and left display 112L) (see FIG. 1). The image mask generator 202, the image generator 203, and the image display unit 204 are connected to one another.

The image mask generator 202 generates an “image mask.” The image mask is a range within which an overlapping image (original image to be described later) is not displayed. The image mask generator 202 may set a range specified by the user as the image mask. The image mask generator 202 provides the generated image mask to an image generator 103.

As in the image generator according to the first embodiment, the image generator 203 generates a display image with the image mask being overlapped with the original image. As in the image display unit according to the first embodiment, the image display unit 204 provides display images to the displays 112 and causes the displays 112 to display the display images.

The image display apparatus 2 has the above-mentioned functional configurations.

[Operations of Image Display Apparatus]

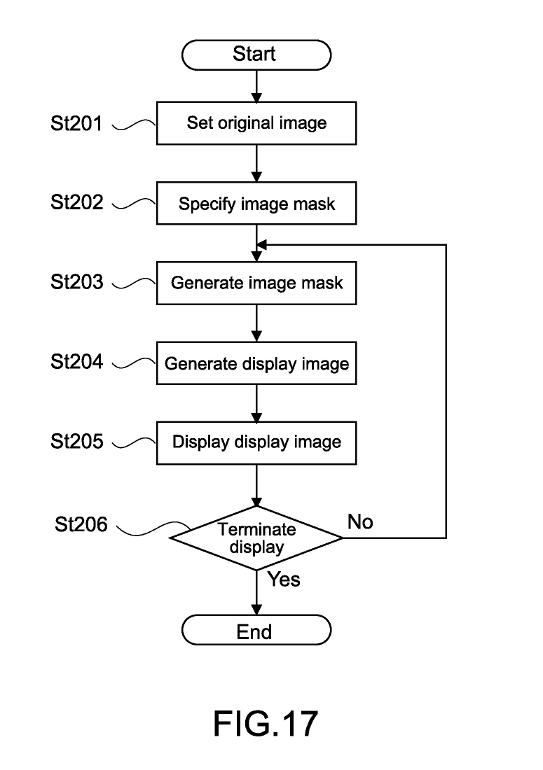

Operations of the image display apparatus 2 will be described. FIG. 17 is a flowchart showing the operations of the image display apparatus 2. Note that, regarding the operations of the image display apparatus 2, an original image A and a capture image G are the same as those according to the first embodiment.

First, the user or the image generator 203 sets the original image A (St201). By operating an operation device 12, the user can select an arbitrary still image or an arbitrary moving image. The selected still image or (each frame of) the selected moving image is set as the original image A. Further, in the case where the user does not select the original image, an image set by the image generator 203 in advance is set as the original image A.

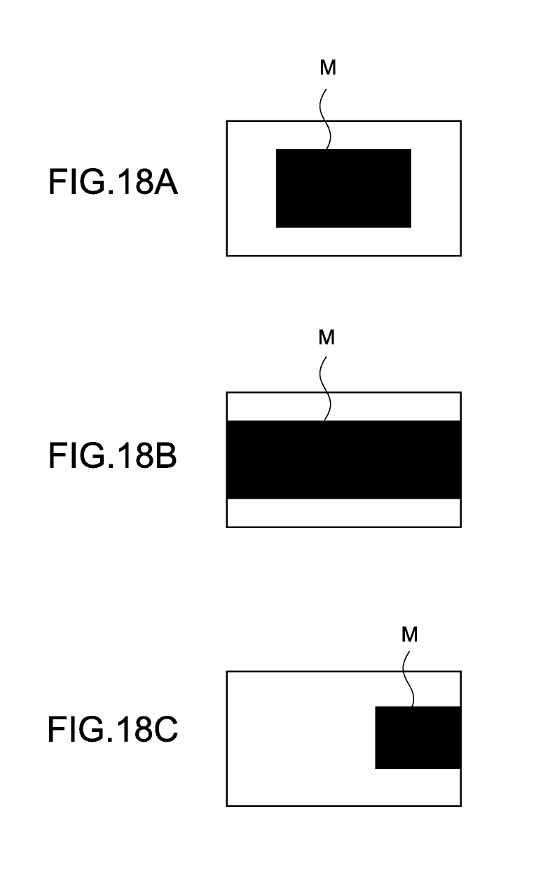

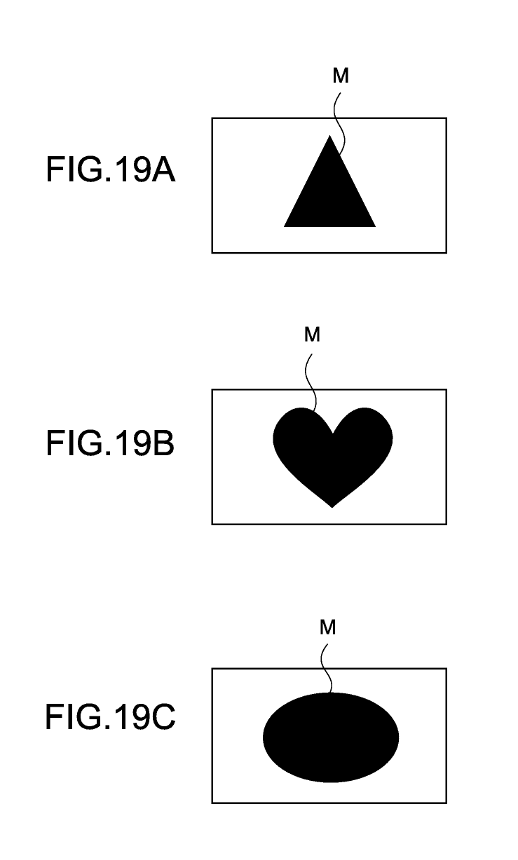

Subsequently, the image mask generator 202 receives specification of the image mask by the user (St202). FIGS. 18 and 19 are schematic views each showing the image mask specified by the user. As shown in FIG. 18A, 18B, and 18C, the user can select an arbitrary one among candidates of the image mask that are set in advance, and specify the arbitrary one as the image mask. Alternatively, as shown in FIGS. 19A, 19B, and 19C, the user may draw an arbitrary shape himself or herself and specify the arbitrary shape as the image mask. Here, it is assumed that the image mask shown in FIG. 18A is specified as the image mask.

Subsequently, the image mask generator 202 generates the image mask specified by the user, as an image mask M (St203). At this time, as in the first embodiment, the image mask generator 202 may receive an instruction by the user, change the size of the image mask M (see FIGS. 14A to 14B) or make a boundary of the image mask blurred (see FIGS. 15A and 15B).

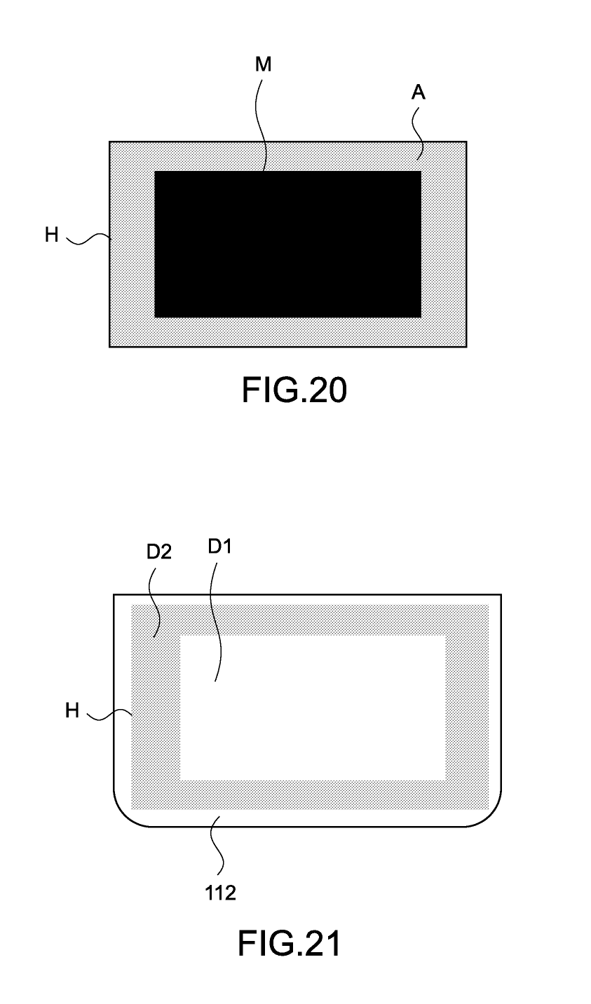

Subsequently, the image generator 203 generates the display image (St204). FIG. 20 is a schematic view showing an example of the display image (hereinafter, referred to as display image H). As shown in the figure, as in the first embodiment, the image generator 203 may generate the display image H with the image mask M being overlapped with the original image A.

Subsequently, the image display unit 204 provides the display images H to the displays 112 and displays the display images H on the displays 112 (St205). FIG. 21 is a schematic view showing one of the display images H to be displayed on the displays 112 (right display 112R and left display 112L). As shown in the figure, the luminance of an area (non-display area) D1 corresponding to the image mask M of the display image H is set to zero, and hence nothing is displayed. On the other hand, the original image A is displayed in an area (display area) D2 other than the area corresponding to the image mask M.

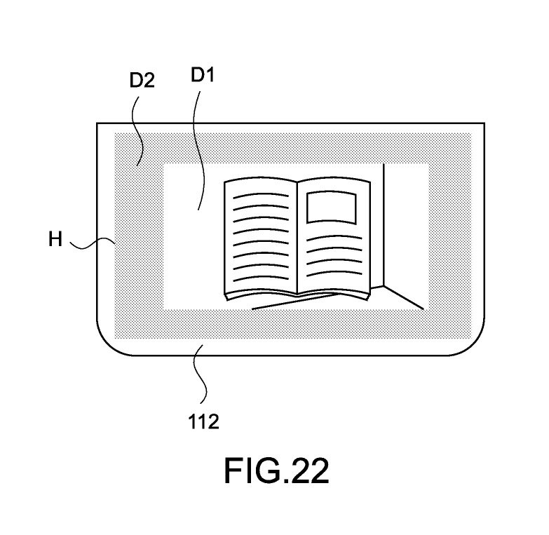

Here, the display 112 is the see-through display, and hence the user can view the object B through the non-display area. FIG. 22 is a schematic view showing vision viewed by the user through the display 112. As shown in the figure, the user can view the object B through the non-display area D1 while the original image A is displayed in the display area D2. With this, the user can view the object B without viewing the surroundings (background) of the object B.

Unless displaying of the display image is stopped by the user (St206: No), steps from the image mask generation (St203) to displaying of the display image (St204) may be repeatedly performed. When displaying of the display image is stopped by the user (St206: Yes), displaying of the display image H is terminated. The image display apparatus 2 performs operations in the above-mentioned manner. As in the first embodiment, when the image display unit 104 displays the original image A in the display area D2 (St205), semi-transparent processing may be performed on the original image A.

The present disclosure is not limited to each of the above-mentioned embodiments and may be modified without departing from the gist of the present disclosure.

In each of the above-mentioned embodiments, the non-display areas are formed in both the right eye display and the left eye display. However, the present disclosure is not limited thereto. The non-display area may be formed in only one display. In this case, the original image may be displayed in the entire portion of the other display.

Further, in each of the above-mentioned embodiments, the display is the see-through display. However, the present disclosure is not limited thereto. The display may be a non-see-through display, a liquid-crystal shutter, or the like. In this case, an image of an object captured by the camera may be displayed in the non-display area.

It should be noted that the present disclosure may also take the following configurations.

(1) An image display apparatus, including:

a see-through display located before an eye of a user;

an image mask generator configured to generate an image mask;

an image generator configured to generate a display image with the image mask being overlapped with an original image; and

an image display unit configured to display the display image on the see-through display.

(2) The image display apparatus according to Item (1), further including:

an imaging unit configured to capture a capture image; and

an object image extraction unit configured to extract, from the capture image, an object image being an image of an object included in a field of view of the imaging unit, in which

the image mask generator is configured to generate an image mask by utilizing a range of the object image in the capture image.

(3) The image display apparatus according to Item (1) or (2), in which

the object image extraction unit is configured to execute edge detection with respect to the capture image and extract the object image.

(4) The image display apparatus according to any one of Items (1) to (3), in which

the image mask generator is configured to set the range of the object image as the image mask.

(5) The image display apparatus according to any one of Items (1) to (4), in which

the image mask generator is configured to set a range specified by the user as the image mask.

(6) The image display apparatus according to any one of Items (1) to (5), in which

the image generator is configured to make a periphery of the image mask blurred and overlap the image mask with the original image.

(7) The image display apparatus according to any one of Items (1) to (6), in which

the image generator is configured to make the original image a semi-transparent image.

(8) An image display program, including:

an image mask generator configured to generate an image mask;

an image generator configured to generate a display image with the image mask being overlapped with an original image; and

an image display unit configured to display the display image on a see-through display located at an eye of a user.

(9) An image display method, including:

generating, by an image mask generator, an image mask;

generating, by an image generator, a display image with the image mask being overlapped with an original image; and

displaying, by an image display unit, the display image on a see-through display located before an eye of a user.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image display apparatus, comprising:
a see-through display located before an eye of a user;
an image mask generator configured to generate an image mask;
an image generator configured to generate a display image with the image mask being overlapped with an original image; and
an image display unit configured to display the display image on the see-through display.

2. The image display apparatus according to claim 1, further comprising:
an imaging unit configured to capture a capture image; and
an object image extraction unit configured to extract, from the capture image, an object image being an image of an object included in a field of view of the imaging unit, wherein
the image mask generator is configured to generate an image mask by utilizing a range of the object image in the capture image.

3. The image display apparatus according to claim 2, wherein
the object image extraction unit is configured to execute edge detection with respect to the capture image and extract the object image.

4. The image display apparatus according to claim 2, wherein
the image mask generator is configured to set the range of the object image as the image mask.

5. The image display apparatus according to claim 1, wherein
the image mask generator is configured to set a range specified by the user as the image mask.

6. The image display apparatus according to claim 1, wherein
the image generator is configured to make a periphery of the image mask blurred and overlap the image mask with the original image.

7. The image display apparatus according to claim 1, wherein
the image generator is configured to make the original image a semi-transparent image.

8. An image display program, comprising:
an image mask generator configured to generate an image mask;
an image generator configured to generate a display image with the image mask being overlapped with an original image; and
an image display unit configured to display the display image on a see-through display located at an eye of a user.

9. An image display method, comprising:
generating, by an image mask generator, an image mask;
generating, by an image generator, a display image with the image mask being overlapped with an original image; and
displaying, by an image display unit, the display image on a see-through display located before an eye of a user.
